(19) United States
(12) Patent Application Publication
(10) Pub. No.: US 2023/0129604 A1
(43) Pub. Date: Apr. 27, 2023

(54) Open Edge Cloud Platform for Location-Sensitive Applications

(71) Applicant: Telefonaktiebolaget LM Ericsson (publ), Stockholm (SE)

(72) Inventor: Zhongwen Zhu, Saint-Laurent (CA)

(21) Appl. No.: 17/918,177

(22) PCT Filed: Apr. 22, 2020
(86) PCT No.: PCT/IB2020/053825

§ 371 Date: Oct. 11, 2022

(51) Int. Cl. G06F 9/50

(52) U.S. Cl. CPC G06F 9/5077; G06F 2209/5011; G06F 2209/5014; G06F 2209/503; G06F 2209/501

(57) ABSTRACT

An open edge cloud platform (OECP) enables tenants to access resources of a pool of network operator to support tenant applications. The tenant can specify a virtual location when requesting creation of a virtual network for a tenant application. The OECP creates a virtual network for the tenant application from available resources of a pool of network operators at the virtual location specified by the tenant in the request. The flexibility of selecting resources from a pool of network operators enables the tenant to access resources closer to the end user devices that will use the tenant application and thus reduce latency for applications and increase data throughput.

### TECHNICAL FIELD

The present disclosure relates generally to cloud-based platforms for providing virtual networking services and, more particularly to an open edge cloud platform for enhancing edge footprints for cloud providers and tenants.

### BACKGROUND

With the rapid evolution of the technology and demand for computing and network capacity, several cloud providers are leading to provide infrastructure as a service, such as Bare Metal as a Service (BMaaS), Virtual Machine as a Service (VMaaS), Software Defined Networks (SDNs) and Virtual Network Functions (VNFs). Cloud providers leading in this effort include Amazon Web Services (AWS), Google Cloud Platform (GCP) and, Azure. Historically, cloud providers have relied on centralized deployments where the bulk of the resources for computation and data storage are centralized in the network. A drawback of the centralized deployment is that the computational and data storage resources may be thousands of miles from the point where the data is collected or used. This distance problem results in longer latency, which can be problematic for many applications.

To avoid the latency problems associated with centralized deployments, cloud providers are moving towards distributed deployments, known as edge computing or edge deployments, where the computational and data storage resources are moved close to the edges of their network. Edge deployments put the computational and data storage resources closer to the devices that collect or use the data and thus avoid some of the latency issues seen in centralized deployments. Cloud providers are working to provide wide coverage or edge footprint to facilitate the clients/consumers access to cloud-based applications and to provide low latency and/or high throughput for tenant applications. While many global cloud providers claim that they have edge footprints deployed around the world, in reality, it is not possible for a single entity to cover all locations. Therefore, technologies that enable cloud providers to extend their coverage or edge footprint are needed.

### SUMMARY

The present disclosure provides an open edge cloud platform (OECP) that enables tenants to access resources of a pool of network operators (NOs) to support tenant applications. The tenant can specify a virtual location when requesting the OECP to create a virtual network for a tenant application The OECP creates a virtual network for the tenant application from available resources of the pool of NOs proximate to the virtual location specified by the tenant in the request. The flexibility of selecting resources from a pool of NOs enables the tenant to access resources closer to the devices that will use the tenant application and thus reduce latency for latency sensitive applications and increase data throughput.

The OECP enables the OECP operator to provide virtual networking services that will be attractive to both tenants, NOs, and end users of tenants' applications. Tenants benefit from the low latency and high throughout provided by the denser edge footprint of the OECP, which helps them meet key performance indicators (KPIs) for location-sensitive applications and increase profits. Network operators and other service providers benefit from access to increased traffic from tenants and end users, which increases revenues and profits realized from infrastructure investments. End users benefit from low latency and higher throughput, which provides an increased quality of service (QoS) and better consumer experience. The virtual network service enabled by the OECP provides the OECP operator with a new revenue stream.

A first aspect of the disclosure comprises methods implemented by a controller in a cloud platform system of providing virtual networking services. The method comprises receiving, from a tenant, a request to create a virtual network. The request includes an indication of a virtual location for the virtual network. The method further comprises creating, responsive to the request, a virtual network including one or more contributing NOs selected from a pool of NOs that have available resources at the virtual location. The method further comprises reserving resources from among the available resources of a selected contributing NO for a tenant application and attaching the reserved resources to the virtual network.

A second aspect of the disclosure comprises a controller in a cloud platform system for providing virtual networking services. The control node is configured to receive, from a tenant, a request to create a virtual network. The request includes an indication of a virtual location for the virtual network. The control node is further configured to create, responsive to the request, a virtual network including one or more contributing NOs selected from a pool of NOs that have available resources at the virtual location. The control node is further configured to reserve resources from among the available resources of a selected contributing NO for a tenant application and attach the reserved resources to the virtual network.

A third aspect of the disclosure comprises a controller for a cloud platform system for providing virtual networking services. The control node comprises communication circuitry for communicating with tenant and with NOs and processing circuitry. The processing circuitry is configured to receive, from a tenant, a request to create a virtual network. The request includes an indication of a virtual location for the virtual network. The processing circuitry is further configured to create, responsive to the request, a virtual network including one or more contributing NOs selected from a pool of NOs that have available resources at the virtual location. The processing circuitry is further configured to reserve resources from among the available resources of a selected contributing NO for a tenant application and attach the reserved resources to the virtual network.

A fourth aspect of the disclosure comprises a computer program for a controller in a cloud platform system configured to provide virtual networking services. The computer program comprises executable instructions that, when executed by processing circuitry in a controller, causes the controller to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

### BRIEF DESCRIPTION OF THE DRAWINGS

FIG. 1 illustrates an exemplary architecture of an OECP as herein described.

FIG. 2 illustrates various forms of tenant-defined virtual locations.

FIG. 3 illustrates an exemplary OECP infrastructure for providing the OECP.

FIG. 4 illustrates traffic routing for a tenant's application in a virtual network created by the OECP.

FIG. 5 illustrates a signaling flow for provisioning Bare Metal (BM) resources for a tenant application at a single NO location.

FIG. 6 illustrates a signaling flow for provisioning Virtual Machine (VM) resources for a tenant application at a single NO location.

FIG. 7 illustrates a signaling flow for provisioning BM resources for a tenant application in a region encompassing multiple NO locations.

FIG. 8 illustrates a signaling flow for provisioning VM resources for a tenant application in a region encompassing multiple NO locations.

FIG. 9 illustrates a method implemented by the OECP controller for the OECP.

FIG. 10 illustrates functional units of an OECP controller for the OECP.

FIG. 11 illustrates the main components of an OECP controller in the OECP.

### DETAILED DESCRIPTION

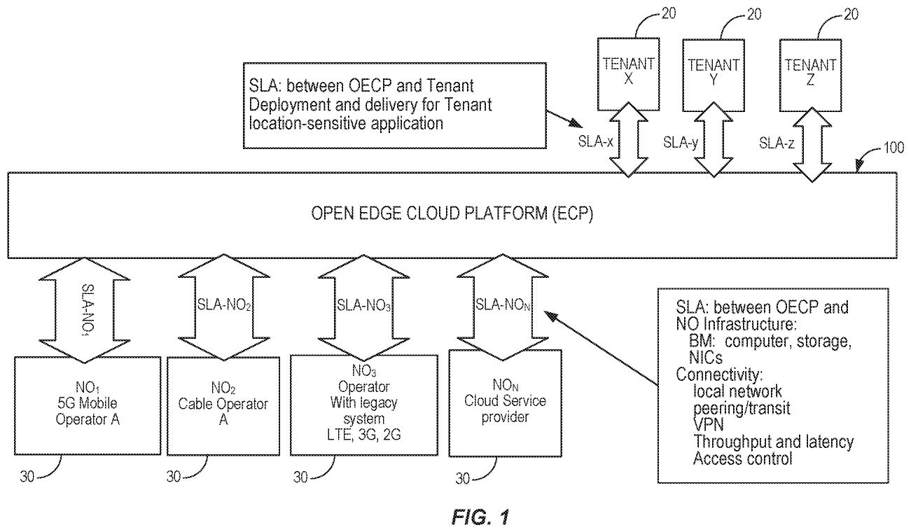

Referring now to the drawings, FIG. 1 illustrates an OECP 100 for providing infrastructure as a service. The OECP 100 extends the traditional business relationship between the service providers (e.g., NOs 30 (NOs 30)) and service consumers (tenants 20). The OECP 100 is built on top of the infrastructure owned by different NOs 30, but the operation of the OECP 100 is carried out by a platform owner, which may be a third party. The NOs 30 join the OECP 100 and make edge resources available to tenants 20 via the OECP 100. Service-level agreements (SLAs) between the OECP operator and NOs 30 define the services and resources that are made available to the OECP 100 by the NOs 30, such as computing power, storage, plus the features required for the network connectivity. The OECP 100 provides virtual networking and infrastructure services (e.g., SDNNNF, VMaaS, BMaaS, etc.) to tenants 20 for location-sensitive applications and is publicly accessible to any tenant 20 who is interested in deploying its application in the cloud. From the tenant's perspective, the tenant 20 deals with a single cloud service provider, i.e., the OECP operator, instead of multiple service providers (e.g., NOs 30). The OECP operator enters into SLAs with tenants 20 that define the deployment and delivery requirements for the tenant's location-sensitive applications. One aspect of the disclosure is the introduction of “virtual location” from the viewpoint of the tenant 20 into the virtual networking services provided via the OECP 100. The virtual location can be viewed and utilized by tenants 20 for deploying its location-sensitive applications at the edge footprint of the infrastructure provided by different NOs 30. The OECP 100 framework maps the tenant-defined virtual location to a list of NO locations, referred to herein as edge footprints, that reflect the physical deployment location of resources in the NO networks and provisions resources for the tenant application based on the tenant-defined location.

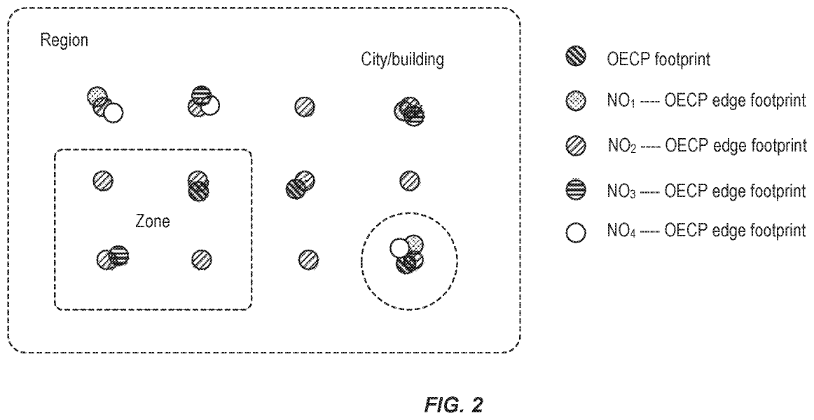

FIG. 2 illustrates various forms of location that can be used in the OECP 100. The virtual location is a digital representation of the places where the tenant 20 has an interest in deploying its application instances in order to provide the application service to its subscribers or customers efficiently and with low latency. The application instances may comprise Bare Metal (BM) instances, Virtual Machine (VM) instances or Kubernetes (K8) clusters. As shown in FIG. 2, the virtual location may be single point of presence (PoP), an area defined in two dimensions (e.g., city, region or zone), a three dimensional space (e.g., building), or N dimensional space where N>3. The definition of the location includes the number of dimensions and a description of its boundaries. The number of dimensions is 1 for a location with a single PoP, 2 for an area with multiple PoPs, 3 for a 3D space with multiple PoPs and N for a multi-dimensional space with multiple PoPs. A point location can be described by geo-coordinates in a geo-coordinate system. The boundaries for an area or space can be described, for example, using a metes and bounds description of the area or space using a geo-coordinate system. An area or space in three dimensions can also be defined by a center point and a radius. Those skilled in the art will appreciate that these are only a few examples and that many other ways exist for describing boundaries of an area or space.

In one embodiment, the tenant 20 specifies a “Region”, “Zone”, “City” or “Building” for a virtual public/private network. The OECP 100 maps the tenant-defined virtual location to one or more NO locations or PoPs where physical resources are deployed. A NO location can be any location where one or more NOs have resources or PoPs. Referring to FIG. 2, four NOs 30 have PoPs in Zone1. NO2 has four PoPs in Zone 1, NO3 has one PoP and the OECP 100 has its own PoP. If the tenant 20 specifies Zone1 in a request to create a virtual private/public network, the OECP 100 can select one or more of the available PoPs of NO2 and NO3 to include in the virtual public/private network. As another example, the PoP highlighted by the dotted circle is served by three NOs 30 as well as the OECP, which would be highly unlikely for a single cloud provider. In this case, the OECP 100 can create a virtual network for this location including the resources of one or multiple NOs 30.

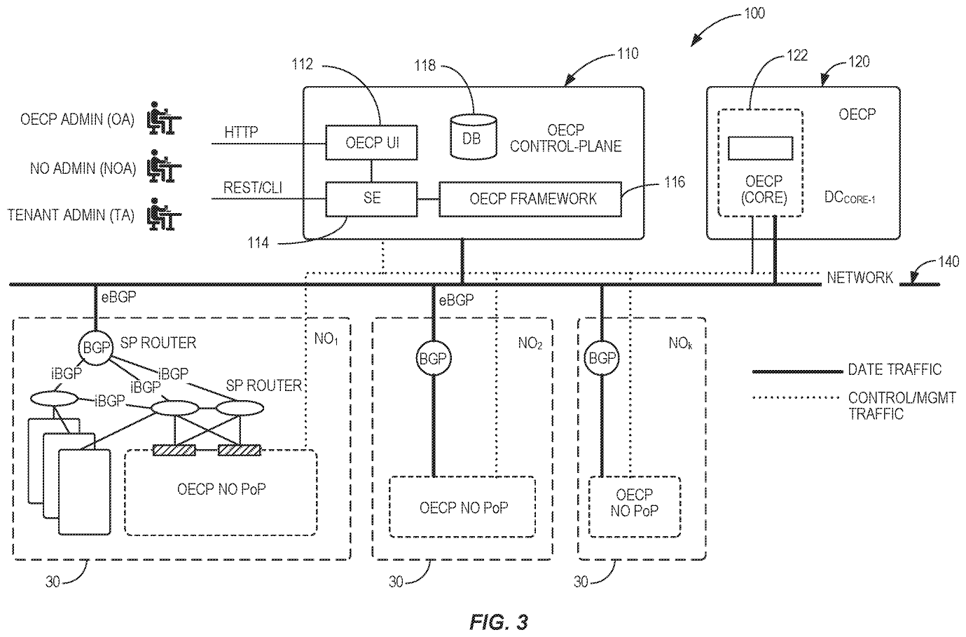

FIG. 3 illustrates the OECP infrastructure and network connectivity for an OECP 100 with multiple NOs 30. The OECP 100 comprises an OECP control plane 110 and OECP core 120. The OECP control plane 110 has the primary responsibility for the control of the OECP.

The OECP control plane 110 includes an OECP user interface (OECP UI) 112 for the OCEP administrator and service exposure (SE) 114 implementing a Representational State Transfer (REST) Application Programming Interface (API) for NOs 30 and tenant administrators. The OECP framework 116, also referred to herein as the OECP controller, contains the bulk of the control logic and stores data related to virtual networking services in the OECP database (118).

The OECP framework 116 manages the resources provided by NOs 30 and consolidates those resources and provide “IaaS” to its tenants. The OECP framework 116 also monitors the network traffic status (e.g., congestion via throughput, latency, packet loss, etc.) as well as workload on the resources (e.g., CPU load, memory usage, latency etc.). Based on these statuses and the given criteria, the OECP framework 116 optimizes the network traffic by redistributing the resources (instances) in different networks or by routing the traffic through different networks dynamically. the OECP framework 116 also perform authentication and authorization for tenants and NOs 30. The OECP core 120 comprises physical resources 122 available for tenant use that are owned and controlled by the OECP.

The participating NOs 30 connect to the OECP 100 via a wide area network (WAN) 140, such as the Internet. The WAN 140 can be public or private. Each NO 30 contributes different kinds of hardware (HW) to the OECP 100. For example, NO1 may have five devices equipped with General Processing Units (GPUs) while NO2 may provide four devices with 4-core Central Processing Units (CPUs). The OECP 100 makes these devices available to a tenant 20 and ready for being used by OECP 100 to provide virtual networking services to the tenants 20.

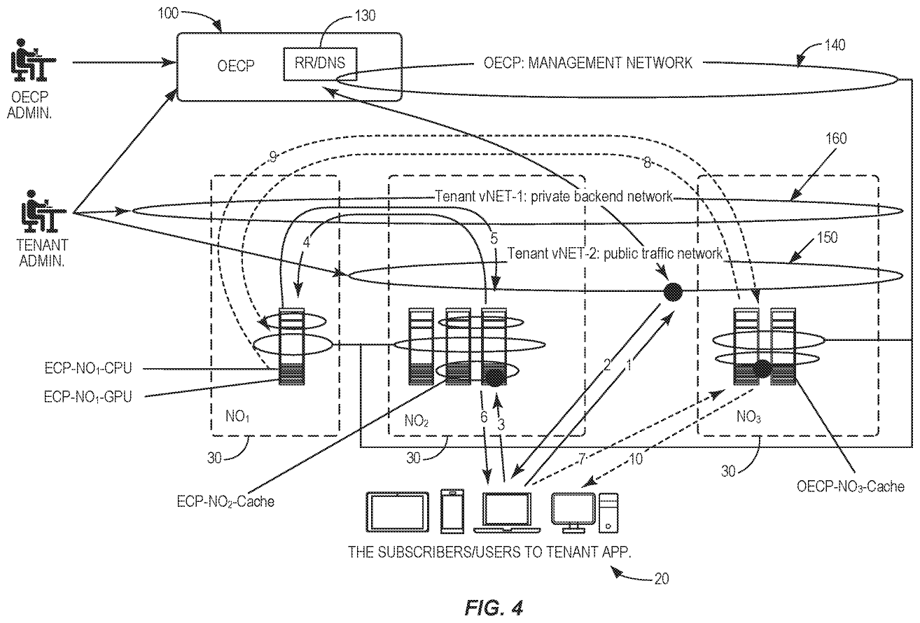

FIG. 4 provides an example of traffic routing for a tenant's location sensitive application. In this example, the OECP 100 creates two virtual networks (vNETS) for the tenant 20; a public vNET 150 accessible to the public and a private vNET 160 for the tenant's backend. The private vNET 160 includes edge footprints of three NOs 30, while the public vNET 150 includes footprints of two NOs 30. The private vNET 160 is used to allow the front end of the tenant application to communicate with its backend in a secure way. The devices located in NO1 are computing-intensive units, such as GPUs, while the devices located in NO2 and NO3 are caching-proxy units for which a normal CPU is sufficient.

The public vNET 150 includes two entry points 152 (shown as solid black circles) for traffic from the tenant's clients (end user/device), which are configured with publicly addressable Internet Protocol (IP) addresses. An OECP 100 Request Router (RR) 130 in the OECP network 140 applies the public IP address or Fully Qualified Domain Name (FQDN) to the entry point (solid black circle) that attaches to the tenant 20 virtual public network. As an example, the RR function can be built on top of Domain Name Server (DNS), which is a part of OECP network 140. The routing decision is made based on the routing policy given by tenant administrator or OECP administrator. The policies are provided to the OECP 100 during configuration.

In this example, traffic routing from the end user to the tenant's application proceeds as follows.
1. The client sends a request to the OECP RR to access the tenant application. Before this request is sent, the client traffic might involve the tenant's DNS server, which is omitted here for simplicity.
2. Based on the routing policy, the OECP RR (DNS) redirects the client request to the tenant's application deployed in the physical public subnet in the infrastructure provided by NO2.
3. The client sends the request to the device in NO2 by following the redirect given by OECP RR.
4. After receiving the client request, the front-end of the tenant application has to communicates with its backend in NO1 to handle certain business logic (computing intensive operation) via the private vNET 160.
5. The backend sends the response back to the tenant application in NO2.
6. The tenant application sends the response back to the client

In case that the instances in NO2 are not available, the client traffic will be directed to the instances located in NO3. In this way, the tenant application achieves its high availability (HA) towards its clients. Referring back to FIG. 4,

An alternative of handling HA for tenant application is for RR to redirect the client request to both instances in NO2 and NO3 in a round robin fashion.

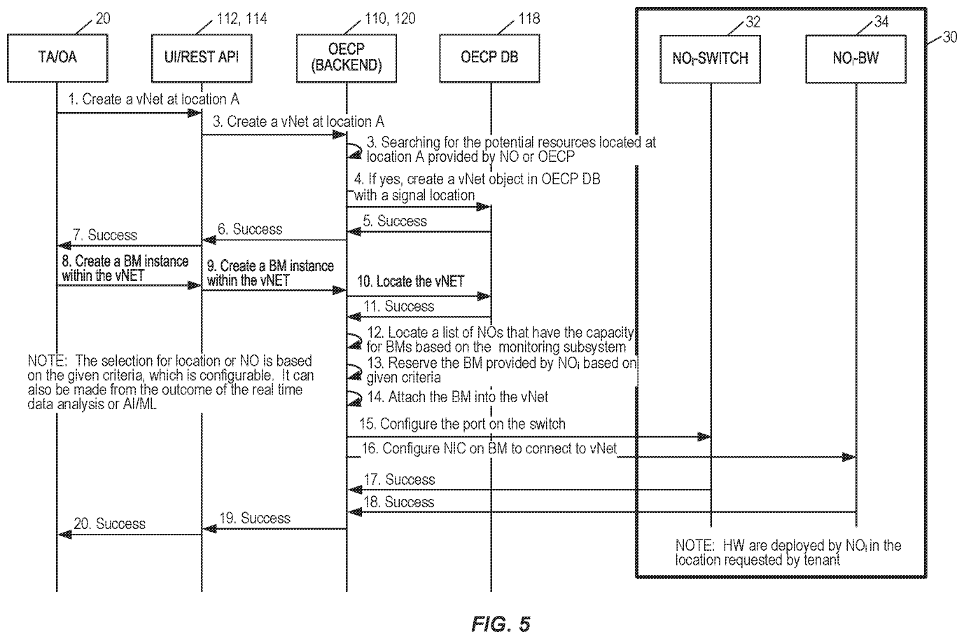

FIG. 5 illustrates an exemplary signaling flow for provisioning a BM instance for a virtual network. In this example, it is assumed that the location provided by the tenant 20 is a point location covered by one or more NOs 30. The OECP 100 includes a backend, also referred to as the OECP controller, that is accessible via a user interface (UI) and/or REST/API. The process proceeds as follows.
1-2. The tenant administrator (TA) or OECP administrator (OA) sends a request to the OECP backend 110 via the UI/REST API 112, 114 to create a vNET. The request includes a virtual location, denoted Location A, which in this example is a single point.
3. The OECP backend 110 searches for available resources proximate to the virtual location specified in the request. The physical locations of the resources do not need to exactly match the virtual location. Rather, the OECP backend 110 searches for all available resources in the proximity of the virtual location specified by the tenant 20. The resources may belong to a NO 30 or to the OECP 100, which can also be a service provider. For example, the OECP 100 could offer K8 clusters as a resource. The determination of proximity can be based on predetermined criteria, such as a predetermined distance criterion. In another embodiment, the n resources closest to the virtual location may be considered proximate the virtual location regardless of distance.
4. If resources are found for the virtual location specified in the request, the OECP backend 110 sends a request to the OECP database (DB) 118 to create a vNET object with a single NO location or footprint.
5-7. The OECP DB 118 creates the vNET object and responds to the request to indicate successful creation of the vNET object. The response is forwarded back to the TA/OA via the UI/REST API.
8-9. After creation of the vNET, the TA/OA sends a request to the OECP backend 110 to create a BM instance for a tenant application.
10-11. OECP backend 110 queries the OECP DB 118 to locate the vNET for the tenant 20 and the OECP 100 returns a list of NOs 30 in the vNET.
12. The OECP monitoring subsystem 122 determines which NOs 30 have capacity for the BM instance.
13-14. Based on predetermined selection criteria provided by the tenant 20 or OECP policy and the input from the monitoring subsystem 122, the OECP backend 110 reserves a BM instance contributed by one of the NOs 30 and attaches the reserved BM instance to the vNET.
15, 17. The OECP backend 110 sends a configuration message to the NO-switch 32 to configure a port for the BM connection to the vNET. The NO-switch 32 answers to indicate successful configuration of the port for the BM instance.
16, 18. The OECP backend 110 sends a configuration message to the BM instance 34 to configure the Network Interface Card (NIC) on the BM instance 34 for connection with the vNET. The BM instance 34 answers to indicate successful configuration of the NIC for connection to the vNET.
19-20. The OECP backend 110 answers the request to create the BM instance via the UI/REST API.

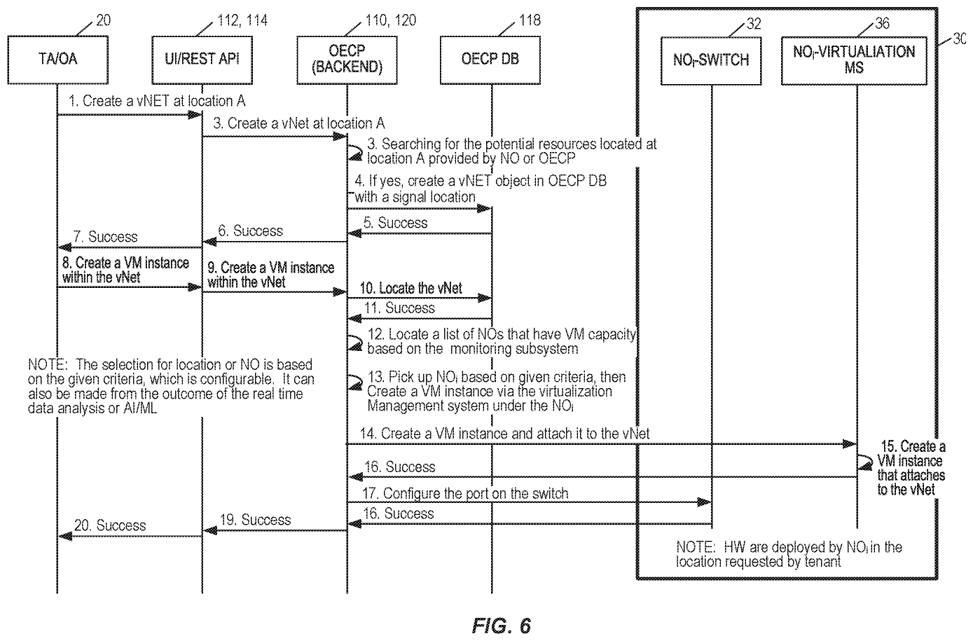

FIG. 6 illustrates an exemplary signaling flow for provisioning a VM instance for a virtual network. In this example, it is assumed that the location provided by the tenant 20 is a point location covered by one or more NOs 30. The process proceeds as follows.
1-7. Same as FIG. 5.
8-9. After creation of the vNET, the TA/OA sends a request to the OECP backend 110 to create a VM instance for a tenant application.
10-11. OECP backend 110 queries the OECP DB 118 to locate the vNET for the tenant 20 and the OECP 100 returns a list of NOs 30 in the vNET.
12. The OECP backend 110 determines a list of NOs 30 that have capacity for the VM instance based on its own monitoring subsystem 122.
13. Based on predetermined selection criteria provided by the tenant 20 or OECP policy and the input from the monitoring subsystem 122, the OECP backend 110 selects a contributing NO 30 with capacity for the VM instance.
14-16. The OECP backend 110 sends a request to the virtualization management system (VMS) 36 of the selected NO 30 to create a VM instance and attach it to the vNET. The VMS 36 creates the VM instance, attaches it to the vNET and answers the request to indicate that the VM instance was successfully created.
17-18. The OECP backend 110 sends a configuration message to the NO-switch 32 to configure a port for the VM connection to the vNET. The NO-switch 32 answers to indicate successful configuration of the port for the VM instance.
19-20. The OECP backend 110 answers the request to create the BM instance from the TA/OA via the UI/REST API.

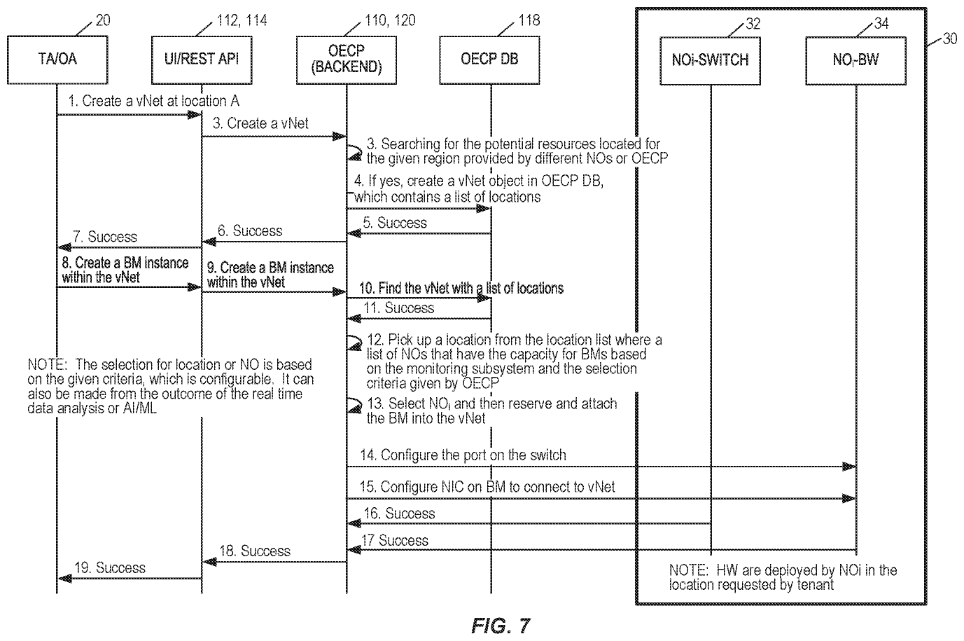

FIG. 7 illustrates an exemplary signaling flow for provisioning a BM instance for a virtual network spanning a region. In this example, it is assumed that the location provided by the tenant 20 is an area or region where one or more NOs 30 have multiple PoPs. The process proceeds as follows.
1-2. The tenant administrator (TA) or OECP administrator (OA) sends request to the OECP backend 110 via the UI/REST API 112, 114 to create a vNET. The request identifies a region to be covered by the vNET.
3. The OECP backend 110 searches for available resources for the region specified in the request. The physical locations of the resources do not need to be within the exact boundaries of the region but may include PoPs within the boundaries or PoPs proximate the boundaries of the region.
4. If resources are found for the region specified in the request, the OECP backend 110 sends a request to the OECP database (DB) 118 to create a vNET object. The request includes a list of NO locations.
5-7. The OECP DB 118 creates the vNET object and responds to the request to indicate successful creation of the vNET object. The response is forwarded back to the TA/OA via the UI/REST API.
8-9. After creation of the vNET, the TA/OA sends a request to the OECP backend 110 to create a BM instance for a tenant application.
10-11. OECP backend 110 queries the OECP DB 118 to locate the vNET for the tenant 20. The OECP backend 110 retrieves the vNET object and returns a list of NO locations or PoPs covered by the vNET.
12. The monitoring subsystem 122 determines which locations in the list of NO locations have capacity for the BM instance. Based on predetermined selection criteria provided by the tenant 20 or OECP policy and the input from the monitoring subsystem 122, the OECP backend 110 selects a NO location from the list of NO locations having capacity for the BM instance.
13. The OECP backend 110 selects a NO at the selected NO location, reserves a BM instance 34 and attaches the reserved BM instance 34 to the vNET
14, 16. The OECP backend 110 sends a configuration message to the NO-switch 32 to configure a port for the BM connection to the vNET. The NO-switch 32 answers to indicate successful configuration of the port for the BM instance 34.
15, 17. The OECP backend 110 sends a configuration message to the BM instance 34 to configure the Network Interface Card (NIC) on the BM instance 34 for connection with the vNET. The BM instance 34 answers to indicate successful configuration of the NIC for connection to the vNET.
18-19. The OECP backend 110 answers the request to create the BM instance from the TA/OA via the UI/REST API.

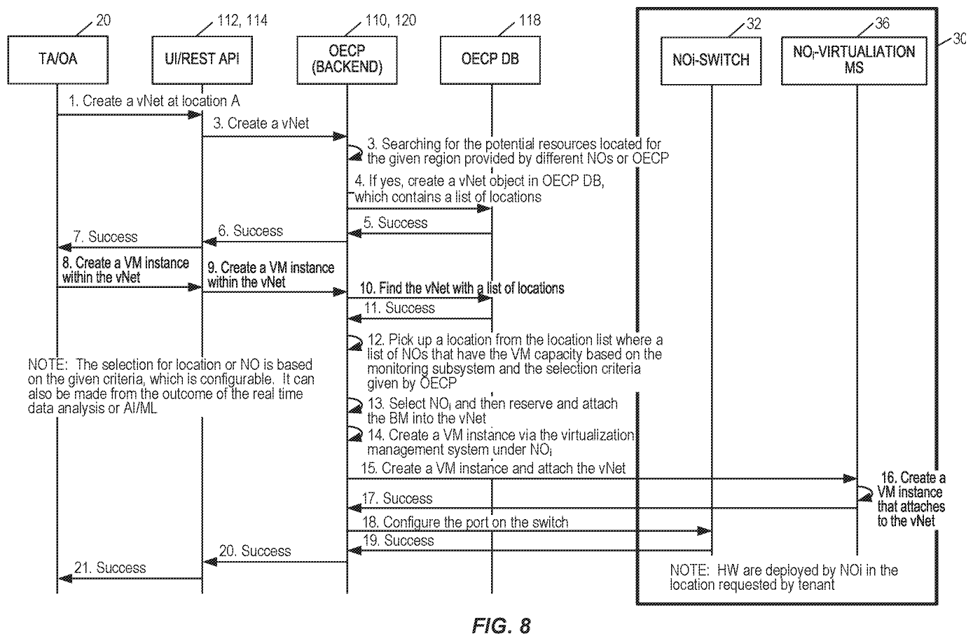

FIG. 8 illustrates an exemplary signaling flow for provisioning a VM instance for a virtual network covering a region with multiple PoPs. The process proceeds as follows.
1-7. Same as FIG. 7.
8-9. After creation of the vNET, the TA/OA sends a request to the OECP backend 110 to create a VM instance for a tenant application.
10-11. OECP backend 110 queries the OECP DB 118 to locate the vNET for the tenant 20 and the OECP 100 returns a list of NOs 30 in the vNET.
12. The OECP backend 110 monitoring subsystem determines a list of NO locations or PoPs that have capacity for the VM instance. Based on predetermined selection criteria provided by the tenant 20 or OECP policy, the OECP backend 110 selects a NO location.
13. The OECP backend 110 selects a contributing NO 30 at the selected location with capacity for the VM instance.
14-16. The OECP backend 110 sends a request to the virtualization management system (VMS) 36 of the selected NO 30 to create a VM instance and attach it to the vNET. The VMS 36 creates the VM instance, attaches it to the vNET and answers the request to indicate that the VM instance was successfully created.
17-18. The OECP backend 110 sends a configuration message to the NO-switch 32 to configure a port for the VM connection to the vNET. The NO-switch 32 answers to indicate successful configuration of the port for the VM instance.
19-20. The OECP backend 110 answers the request to create the BM instance from the TA/OA via the UI/REST API.

The procedures shown in FIGS. 5-9 provide a few examples to illustrate how provisioning is performed in the OECP 100. A person skilled in the art can extend the provisioning procedures to other types of resources, such as Kubernetes (K8) clusters.

Also, those skilled in the art will appreciate that the vNET created by the OECP 100 is not necessarily static but can be modified after its creation. For example, the monitoring subsystem 122 of the OECP 100 can detect when a new PoP for an existing NO 30 or a new NO 30 is available and add the new NO/PoP to the virtual network. Similarly, the OECP monitoring subsystem can detect when an existing NO 30 or PoP has failed or is no longer available and remove the NO/PoP from the virtual network. In either of these scenarios, the OECP 100 can migrate a tenant application from current resources used by the tenant application to new resources of a new or existing NO. Similarly, the monitoring subsystem may migrate a tenant application for purposes of load balancing or to provide a higher QoS for the tenant application. The procedures for migrating a tenant application are similar to those described above for the initial provisioning and can be performed transparently from the point of view of the tenant application.

A tenant application can also be moved from one resource to another resource of a different type depending, for example, QoS requirement and performance history. For example, better performance for a tenant application may be achieved by moving a tenant application from a BM instance to a VM instance or vice versa. The target resources for the migration can be with the same NO 30 or with a different NO 30.

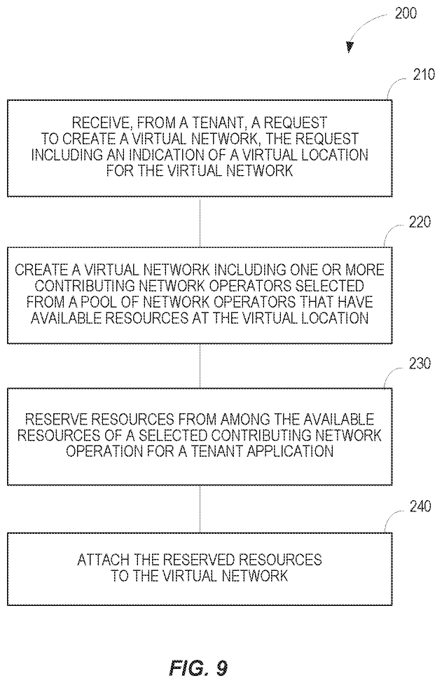

FIG. 9 illustrates an exemplary method 200 implemented by a controller for an OECP 100 of providing infrastructure as a service. The method 200 comprises receiving, from a tenant 20, a request to create a virtual network, the request including an indication of a virtual location for the virtual network (block 210). The method 200 further comprises creating, responsive to the request, a virtual network including one or more contributing NOs 30 selected from a pool of NOs 30 that have available resources at the virtual location (block 220). The method 200 further comprises reserving resources from among the available resources of a selected contributing NO for a tenant application and attaching the reserved resources to the virtual network. (blocks 230, 240).

In some embodiments of the method 200, the virtual location comprises a point location served by one or more NOs 30.

In some embodiments of the method 200, reserving at least a part of the available resources of a selected contributing NO comprises selecting a NO from a list of contributing NOs 30 having remaining capacity for the tenant application, and reserving resources from among the available resources of the selected NO for the tenant application.

In some embodiments of the method 200, the virtual location comprises a two-dimensional area served by one or more NOs 30.

In some embodiments of the method 200, the virtual location comprises a three-dimensional space served by one or more NOs 30.

In some embodiments of the method 200, the virtual location comprises a N-dimensional space served by one or more NOs 30, where N>3.

In some embodiments of the method 200, reserving at least a part of the available resources of a selected contributing NO comprises selecting a NO location from among a list of NO locations at the virtual location in the first request that have remaining capacity for the tenant application, selecting a NO from a list of contributing NOs 30 having remaining capacity for the tenant application at the selected NO location, and reserving resources from among the available resources of the selected NO for the tenant application.

In some embodiments of the method 200, the reserved resources for the tenant 20 comprise dedicated physical resources.

In some embodiments of the method 200, the reserved resources for the tenant 20 comprise a virtual machine.

In some embodiments of the method 200, the reserved resources for the tenant 20 comprise a Kubernetes cluster.

Some embodiments of the method 200 further comprise determining based on a predetermined criteria to migrate the tenant application reserved resources currently used by the tenant application to target resources of a different contributing NO, and reserving, responsive to the determining, the target resources with the different contributing NO for the tenant application and migrating the tenant application from the reserved resources currently used by the tenant application to the reserved target resources of the different contributing NO.

Some embodiments of the method 200 further comprise, after the virtual network is created, expanding the virtual network to include a new contributing provider at the virtual location specified in the request that is not among the original NOs 30.

Some embodiments of the method 200 further comprise determining based on a predetermined criteria to migrate the tenant application reserved resources currently used by the tenant application to target resources of the new contributing provider, and responsive to the determining, reserving the target resources with the new contributing NO for the tenant application and migrating the tenant application from the reserved resources currently used by the tenant application to the reserved target resources of the new contributing NO.

In some embodiments of the method 200, the reserved target resources are at the same NO location as the reserved resources currently in use.

In some embodiments of the method 200, the reserved target resources are at a different NO location as the reserved resources currently in use.

Some embodiments of the method 200 further comprise determining based on a predetermined criteria to migrate the tenant application from reserved resources of a first type currently used by the tenant application to target resources of a second type, and responsive to the determining, reserving the target resources of the second type for the tenant application and migrating the tenant application from the reserved resources currently used by the tenant application to the reserved target resources. In some embodiments of the method 200, the target resources of the second type are with the same contributing network operator as the reserved resources of a first type currently used by the tenant application.

In some embodiments of the method 200, the target resources of the second type are with a different contributing network operator as the reserved resources of a first type currently used by the tenant application.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

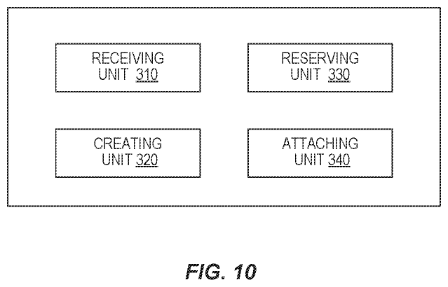

FIG. 10 illustrates an exemplary controller 300 for an OECP 100 according to an embodiment configured to perform the method 200 of FIG. 9. The controller 300 comprises a receiving unit 310, a creating unit 320, a reserving unit 330 and an attaching unit 340. The various units 310-340 can be implemented by hardware and/or by software code that is executed by a processor or processing circuit. The receiving unit 310 is configured to receive, from a tenant 20, a request to create a virtual network. The request includes an indication of a virtual location for the virtual network. The creating unit 320 is configured to create a virtual network including one or more contributing NOs 30 selected from a pool of NOs 30 that have available resources at the virtual location specified in the request. The reserving unit 330 is configured to reserve resources from among the available resources of a selected contributing NO for a tenant application. The attaching unit 340 is configured to attach the reserved resources to the virtual network.

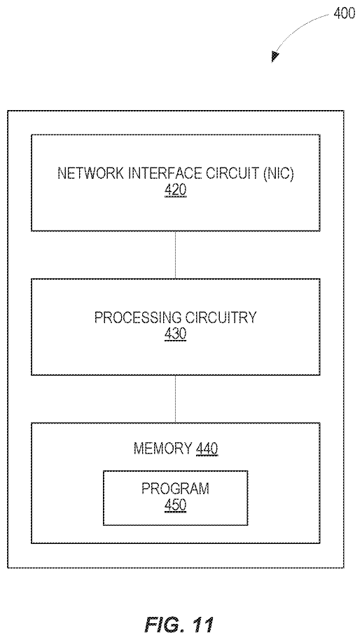

FIG. 11 illustrates the main functional components of a controller 400 that can be configured as a producer network node or consumer network node, or a combination thereof. The controller 400 can be configured to implement the signaling procedures and methods as herein described. The controller 400 comprises communication circuitry 420, processing circuitry 430, and memory 440. The components of the controller 400 can be centralized or distributed.

The communication circuitry 420 comprises network interface circuitry for communicating with tenants 20 and with other NOs 30 over a communication network, such as an Internet Protocol (IP) network.

Processing circuitry 430 controls the overall operation of the controller 400 and is configured to implement the procedures shown in FIGS. 5-8 and the method 200 shown in FIG. 9. The processing circuitry 430 may comprise one or more microprocessors, hardware, firmware, or a combination thereof configured to perform the method 200 shown in FIG. 9.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage. Memory 440 stores a computer program 450 comprising executable instructions that configure the processing circuitry 430 to implement the method shown in FIG. 9. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

The OECP 100 as herein described creates a virtual network for the tenant application from available resources of a pool of NOs 30 at a virtual location specified by the tenant 20 in the request. The flexibility of selecting resources from a pool of NOs 30 enables the tenant 20 to access resources closer to the devices that will use the tenant application and thus reduce latency and increase data throughput.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-24. (canceled)

25. A method implemented by a cloud platform system providing infrastructure as a service, the method comprising:
receiving, from a tenant, a request to create a virtual network, the request including an indication of a virtual location for the virtual network;
creating a virtual network including one or more contributing network operators selected from a pool of network operators that have available resources at the virtual location;
reserving resources from among the available resources of a selected contributing network operator for a tenant application; and
attaching the reserved resources to the virtual network.

26. The method of claim 25, wherein the virtual location comprises a point location served by one or more network operators.

27. The method of claim 26, wherein reserving at least a part of the available resources of a selected contributing network operator comprises:
selecting a network operator from a list of contributing network operators (30) having remaining capacity for the tenant application;
reserving resources from among the available resources of the selected network operator for the tenant application.

28. The method of claim 25, wherein the virtual location comprises a two-dimensional area served by one or more network operators.

29. The method of claim 25, wherein the virtual location comprises a three-dimensional space served by one or more network operators.

30. The method of claim 25, wherein the virtual location comprises a N-dimensional space served by one or more network operators, where N>3.

31. The method of claim 28, wherein reserving at least a part of the available resources of a selected contributing network operator comprises:
selecting a NO location from among a list of NO locations at the virtual location in the first request that have remaining capacity for the tenant application;
selecting a network operator from a list of contributing network operators having remaining capacity for the tenant application at the selected NO location; and
reserving resources from among the available resources of the selected network operator for the tenant application.

32. The method of claim 25, wherein the reserved resources for the tenant application comprise dedicated physical resources.

33. The method of claim 25, wherein the reserved resources for the tenant application comprise a virtual machine.

34. The method of claim 25, wherein the reserved resources for the tenant comprise a Kubernetes cluster.

35. The method of claim 25, further comprising:
determining based on a predetermined criteria to migrate the tenant application from reserved resources currently used by the tenant application to target resources of a different contributing network operator; and
responsive to the determining, reserving the target resources with the different contributing network operator for the tenant application and migrating the tenant application from the reserved resources currently used by the tenant application to the reserved target resources of the different contributing network operator.

36. The method of claim 25, further comprising, after the virtual network is created, expanding the virtual network to include a new contributing provider at the virtual location specified in the request that is not among the original network operators.

37. The method of claim 36, further comprising:
determining based on a predetermined criteria to migrate the tenant application from reserved resources currently used by the tenant application to target resources of the new contributing provider; and
responsive to the determining, reserving the target resources with the new contributing network operator for the tenant application and migrating the tenant application from the reserved resources currently used by the tenant application to the reserved target resources of the new contributing network operator.

38. The method of claim 36, wherein the reserved target resources are at the same NO location as the reserved resources currently in use.

39. The method of claim 36, wherein the reserved target resources are at a different NO location as the reserved resources currently in use.

40. The method of claim 25, further comprising:
determining based on a predetermined criteria to migrate the tenant application from reserved resources of a first type currently used by the tenant application to target resources of a second type; and
responsive to the determining, reserving the target resources of the second type for the tenant application and migrating the tenant application from the reserved resources currently used by the tenant application to the reserved target resources.

41. The method of claim 40, wherein the target resources of the second type are with the same contributing network operator as the reserved resources of a first type currently used by the tenant application.

42. The method of claim 40, wherein the target resources of the second type are with a different contributing network operator as the reserved resources of a first type currently used by the tenant application.

43. A controller for an open edge cloud platform (OECP) providing infrastructure as a service, the controller comprising:
communication circuitry for communicating with network operators (30) and tenants; and
processing circuitry configured to:
receive, from a tenant, a request to create a virtual network, the request including an indication of a virtual location for the virtual network;
create a virtual network including one or more contributing network operators (30) selected from a pool of network operators (30) that have available resources at the virtual location;
reserve resources from among the available resources of a selected contributing network operator for a tenant application; and
attach the reserved resources to the virtual network.
